(19) United States
(12) Patent Application Publication
(10) Pub. No.: US 2009/0211686 A1
(43) Pub. Date: Aug. 27, 2009

(54) Method for Extending the Life of Golf Course Equipment

(75) Inventor: Phil Cowen, New York, NY (US)

Correspondence Address: PATENT DOCKET ADMINISTRATOR;LOWENSTEIN SANDLER PC, 65 LIVINGSTON AVENUE, ROSELAND, NJ, 07068, US

(73) Assignee: INSULTAB, INC., Woburn, MA (US)

(21) Appl. No.: 12/036,788

(22) Filed: Feb. 25, 2008

(51) Int. Cl. B32B 37/00; A63B 57/00

(52) U.S. Cl. 156/60; 473/173

(57) ABSTRACT

The present invention provides weather and use-protected golf course equipment, and methods of extending the useful life golf course equipment by protecting it against weather and use, via application of a heat shrinkable material onto the equipment.

Maintaining a golf course is an arduous task and requires ample time and money. In addition to the upkeep of the fairway, rough, bunkers and water hazards, equipment used on the course also needs to be maintained. Harsh weather, including snow and rain, can cause flagsticks to erode, and the constant insertion and removal of hazard stakes into the ground can cause the stakes to weaken and splinter. The sun also plays a major part in eroding equipment, causing the splintering of fiberglass. Colors can also fade due to exposure to ultraviolet rays. Even everyday use can take a toll, resulting in cracking, staining and splintering of equipment. Ball and club hits can result in nicks and scratches, and even regular placement of equipment onto the ground or in conveyance vehicles can result in damage to the equipment.

The majority of golf course equipment is manufactured from fiberglass because it is lightweight, flexible, and cost-effective. However, fiberglass equipment especially feels the brunt of the damage due to everyday use, as even the most minimal nick or scratch can cause the fiberglass to prematurely erode and splinter. Additionally, exposure to ultraviolet light can cause the fiberglass resins to dry out which also leads to splintering.

Currently, only quick-fix solutions are available to mend damaged golf course equipment, e.g., sanding and painting, which only provide a short-term solution, and does not protect against recurring damage.

Thus, there remains a need to provide protection for golf course equipment against such damaging conditions. The golf course equipment and methods of the present invention address these issues by reducing the need for constant repair, maintenance and replacement of golf course equipment.

### OBJECTS AND SUMMARY OF THE INVENTION

It is an object of the present invention to provide a method of repairing and/or extending the life of golf course equipment comprising (a) contacting at least a portion of golf course equipment with a heat shrinkable material and (b) applying an effective amount of heat to the heat shrinkable material to shrink the heat shrinkable material onto the equipment, while maintaining the integrity of the equipment.

It is an object of the present invention to provide golf course equipment that has been repaired or protected using the methods described herein.

In preferred embodiments, the method of the present invention further comprises applying a suitable adhesive onto either the golf course equipment in contact with the heat shrinkable material, or the heat shrinkable material prior to contacting the equipment with the heat shrinkable material.

In certain embodiments of the present invention, the excess heat shrinkable material remaining after the heat shrinkable material has shrunken onto the equipment is trimmed away.

In certain embodiments of the present invention, the heat shrinkable material is a flat sheet, tape or tubing. In most preferred embodiments, the heat shrinkable material is tubing.

In certain embodiments of the present invention, the heat shrinkable material is a material selected from the group consisting of a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, and mixtures or variations thereof. In preferred embodiments, the heat shrinkable material comprises polyvinyl chloride.

In certain embodiments of the present invention, the heat shrinkable material comprises at least one additive selected from the group consisting of a colorant, a tackifier, a filler, a plasticizer, a processing oil, an antimicrobial agent, a UV curing agent, a magnetic/magnetizable material and mixtures thereof.

In preferred embodiments, the heat shrinkable material shrinks onto the equipment when the material reaches a temperature from about 85° C. to about 200° C. In more preferred embodiments, the heat shrinkable material shrinks at about 100° C.

For purposes of the present invention, the terms “golf course equipment” and “equipment” are used interchangeably and include, but are not limited to, flagsticks, bunker rakes, stakes, including hazard stakes and out-of-bounds stakes, bench slats and distance posts.

For the purposes of the present invention, the term “recovered” or “recovery” refers to the stage of the heat shrinkable material after it has undergone shrinkage by a heat source.

For the purposes of the present invention, the phrase “fully recovered” refers to heat shrinkable material that has undergone maximum shrinkage.

For the purposes of the present invention, the phrase “partially recovered” refers to heat shrinkable material that has not undergone maximum shrinkage.

For purposes of the present invention, the phrase “protective covering” refers to the heat shrinkable material after it has shrunken onto the equipment.

### DETAILED DESCRIPTION

As disclosed above, the method of the present invention provides for a method of repairing or extending the useful life of golf course equipment. The golf course equipment of the present invention is covered with a heat shrinkable material which protects the covered portions of the equipment, thus minimizing the maintenance issues commonly associated with such equipment after use and exposure to the elements, e.g., splintering, faded colors, dirt, scratches, nicks, cracking, stains, etc.

The method of the present invention comprises contacting suitable golf course equipment with a heat shrinkable material and applying heat to the heat shrinkable material to shrink the heat shrinkable material onto the equipment. The heat is applied at an appropriate temperature to allow for the heat shrinkable material to adhere to the equipment, while still maintaining the integrity of the equipment.

The method of the present invention provides a rugged, tight-fitting, hazard resistant protective covering which, in certain embodiments, also provides protection against ultraviolet light. In addition to these advantages, the heat shrinkable material is also easy to apply and can be used by virtually anyone with minimal instruction, and can be applied to a variety of materials, including for example, fiberglass, wood and metal.

A further advantage of the present invention is that, in certain embodiments, the shrunken heat shrinkable material may be removed from the equipment. For example, a shallow incision may be made into the shrunken heat shrinkable material which was previously shrunken on the equipment, and the shrunken material may then be peeled off of the equipment. This allows for easy replacement of the shrunken heat shrinkable material, if necessary.

The heat shrinkable material used in the present invention may be made of any material known in the art which exhibits properties of a protective covering and is shrinkable via heat, e.g., a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, or mixtures or variations thereof. In preferred embodiments, the heat shrinkable material comprises polyvinyl chloride (PVC).

The heat shrinkable material will recover, or shrink down, to a smaller size when appropriate heat is applied. The thickness of the recovered heat shrinkable material depends upon the degree of recovery. For example, heat shrinkable material which is fully recovered will have a greater thickness than heat shrinkable material which is only partially recovered. Heat shrinkable material that has fully recovered can be half of the size or less of the material prior to sufficient heat exposure. With this in mind, the heat shrinkable material shrunken onto the equipment is preferably of an appropriate thickness to protect the equipment from the undesirable effects of everyday use and environmental conditions. Thus, in preferred embodiments, the heat shrinkable material is from about 0.030 inches to about 0.100 inches thick after recovery and more preferably from about 0.030 to about 0.050 inches thick.

An adhesive agent may optionally be applied to either the portion of the golf course equipment to be covered with the heat shrinkable material, or to the heat shrinkable material itself prior to the application of the heat shrinkable material onto the equipment. Any suitable multipurpose adhesive agent may be used, and one of skill in the art would recognize which multipurpose adhesives would be applicable for the methods describes herein.

The shrinking of the heat shrinkable material onto the equipment not only provides protection for the equipment, but also provides a smooth, aesthetically pleasing surface. To add to the cosmetic appearance of the protective covering, the heat shrinkable material used in the present invention may be clear or any particular color, depending on the user's preference. In certain embodiments, the heat shrinkable material used in the present invention may also be paintable. Additionally, the heat shrinkable material used may be high gloss, matte, metallic, neon or pearlescent, depending on the user's needs.

Many polymers may be degraded by UV light and pigments and dyes can absorb UV and change color. Therefore, in certain embodiments, the heat shrinkable material used in the present invention provides protection against ultraviolet (UV) light, which helps to maintain the durability and color of the equipment.

The heat source used to shrink the heat shrinkable material may be any heat source known in the art capable of emitting sufficient heat to cause the heat shrinkable material to shrink onto the equipment. Preferably, the temperature emitted from the heat source is from about 100° C. to about 2000° C. A preferred heat source for use in the present invention is a heat gun.

The chart below is an exemplary guide of the preferred width of heat shrinkable material which may be used to cover the listed equipment when the heat shrinkable material is in the shape of a tube. One of skill in the art would recognize the dimensions of heat shrinkable material required to coat particular pieces of equipment depending on the form of the heat shrinkable material and the dimensions of the equipment.

| | Width of Heat shrinkable | Width of Heat shrinkable |
|---|---|---|
| Golf Course Equipment | Material (in.) | Material (cm.) |
| Regulation Flagsticks | from about 0.5 to about 1.0 | from about 1.3 to about 2.5 |
| Tapered Tournament | from about 0.5 to about 1.5 | from about 1.3 to about 3.8 |
| Flagsticks | | |
| Tournament Flagsticks | from about 0.5 to about 2.0 | from about 1.3 to about 5.1 |
| Rake Handles | from about 0.2 to about 1.5 | from about 0.5 to about 3.8 |
| Hazard and Out-of-Bounds | from about 1.0 × 1.0 to about | from about 2.5 × 2.5 to about |
| Square Stakes | 3.0 × 3.0 | 7.6 × 7.6 |
| Round and Square Stakes | from about 1.0 to about 2.0 | from about 2.5 to about 5.1 |
| Misc. | from about 0.2 to about 12.0 | from about 0.5 to about 30.5 |

### EXAMPLES

A tube of heat shrinkable material of particular dimensions was selected according to the equipment to be covered.

### Example 1

### Covering a Flagstick

Heat shrinkable tubing was cut 8.0 in. longer than the length of the flagstick. The flagstick was sprayed with a multipurpose adhesive**, then held vertically and the heat shrinkable tubing was slid onto the flagstick. ** The multi-purpose adhesive spray is an optional step and not required for the heat shrinkable material to adhere onto the equipment.

Heat was applied to the tubing, starting at the bottom of the flagstick, via a heat gun. The heat shrinkable material was pressed downwards towards the ferrule to form a snug fit. The flagstick was rotated throughout the process to ensure even melting of the heat shrinkable material.

The excess tubing was trimmed away from the flagstick, and heat was reapplied to provide a smooth surface.

### Example 2

### Covering a Tapered Flagstick

Heat shrinkable tubing was measured, cut and applied according to Example 1. But, since the shaft was tapered, the shaft was lubricated with soapy water prior to insertion into the tubing for easier application.

### Example 3

### Covering a Square Stake

Heat shrinkable tubing was cut so that excess tubing would be present at both ends of the stake. The tubing was slid onto the stake and heat was applied via a heat gun starting at the middle of the stake and preceded outwards towards each end of the stake. The stake was rotated throughout the process to ensure a snug fit. The excess recovered heat shrinkable material was trimmed away, and heat was reapplied to provide a smooth surface.

### Example 4

### “Making your Own” stake

The “above ground” portion of a stake was covered with tubing, adding an extra 2″ at the top. Heat was applied beginning at the bottom of the stake, working upwards. Excess material was trimmed away at the top. A cap was heated slightly and the placed on the top of the stake. Heat was applied and the cap was pressed into place.

### Example 5

### Changing Color of Equipment (From Darker to Lighter)

White heat shrinkable material was applied to a flagstick, previously covered with a dark color, using the procedure in Example 1. After the flagstick was covered in the white color, the process was repeated with a colored heat shrinkable material.

To go form lighter to darker, the darker tubing is simply placed over the original lighter covering and shrunken on.

### Example 6

### Color Striping

A base color (white) was shrunken over a flagstick. A stripe color was chosen and the heat shrinkable material was cut into strips and shrunken onto the flagstick in a striped pattern.

What is claimed:

1. A method of extending the useful life of golf course equipment comprising:
(a) contacting at least a portion of golf course equipment with a heat shrinkable material;
(b) applying an effective amount of heat to said heat shrinkable material to shrink the heat shrinkable material onto the equipment while maintaining the integrity of the equipment.

2. The method of claim 1, further comprising applying a suitable adhesive onto a portion of the golf course equipment to be contacted with the heat shrinkable material, or the heat shrinkable material prior to step (a).

3. The method of claim 1, further comprising trimming away excess heat shrinkable material after the heat shrinkable material has shrunken onto the equipment.

4. The method of claim 1, wherein the heat shrinkable material is a flat sheet, tape or tubing.

5. The method of claim 1, wherein the heat shrinkable material comprises a material selected from the group consisting of a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, and mixtures thereof.

6. The method of claim 1, wherein the heat shrinkable material comprises polyvinyl chloride.

7. The method of claim 1, wherein said heat shrinkable material comprises at least one additive selected from the group consisting of a colorant, a tackifier, a filler, a plasticizer, a processing oil, an antimicrobial agent, a UV curing agents, a magnetic/magnetizable material and mixtures thereof.

8. The method of claim 1, wherein said heat shrinkable material shrinks at a temperature of about 85° C. to about 200° C.

9. The method of claim 1, wherein said heat shrinkable material provides UV protection.

10. The method of claim 1, wherein the heat shrinkable material has a thickness of from about 0.030 to about 0.50 after recovery.

11. The method of claim 1, wherein said golf course equipment is a rake, a flagpole, a bench slat or a stake.

12. Golf course equipment comprising a heat shrinkable material surrounding at least a portion of the equipment, wherein said heat shrinkable material has been exposed to an effective amount of heat to shrink the heat shrinkable material onto the equipment.

13. The golf course equipment of claim 12, wherein said heat shrinkable material provides protection from damage of the equipment.

14. The golf course equipment of claim 12, further comprising a suitable adhesive disposed between the equipment and the heat shrinkable material.

15. The golf course equipment of claim 12, wherein the heat shrinkable material is in the shape of a flat sheet, tape or tubing prior to application to the equipment.

16. The golf course equipment of claim 12, wherein the heat shrinkable material is a material selected from the group consisting of a reaction product of dicarboxylic acids and diols, a polyolefin material, a copolymer or terpolymer with at least one monomer type of an alpha-olefin, a phenol/formaldehyde material, a phenoxy material, and polyurethane, a styrene butadiene rubber, a modified ethylene copolymer blend, a polyester, an epoxy polyester, and mixtures thereof.

17. The golf course equipment of claim 12, wherein the heat shrinkable material comprises polyvinyl chloride.

18. The golf course equipment of claim 12, wherein said heat shrinkable material comprises at least one additive selected from the group a colorant, a tackifier, a filler, a plasticizer, a processing oil, an antimicrobial agent, a UV curing agents, a magnetic/magnetizable material and mixtures thereof.

19. The golf course equipment of claim 12, wherein said heat shrinkable material shrinks at a temperature of from about 85° C. to about 200° C.

20. The golf course equipment of claim 12, wherein said heat shrinkable material provides protection against UV light.

21. The golf course equipment of claim 12, wherein said golf course equipment is a rake, a flagpole, a bench slat or a stake.

22. A method of extending the useful life of golf course equipment comprising:
(a) inserting at least a portion of golf course equipment into a tubing comprising a PVC-based heat shrinkable material which provides protection against UV light;
(b) exposing the heat shrinkable material to a heat source which causes the temperature of the heat shrinkable material to reach about 90° C. to about 110° C. to shrink the heat shrinkable material onto the equipment while maintaining the integrity of the equipment.
